(19) United States
(12) Patent Application Publication
(10) Pub. No.: US 2007/0006472 A1
(43) Pub. Date: Jan. 11, 2007

(54) Independent personal underwater navigation system for scuba divers

(76) Inventor: Aaron Bauch, Londonderry, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/435,300

(22) Filed: May 16, 2006

Related U.S. Application Data
(60) Provisional application No. 60/681,425, filed on May 16, 2005.

(51) Int. Cl. G01C 17/00

(52) U.S. Cl. 33/355 R

(57) ABSTRACT

An underwater personal Inertial Navigation System (INS) that uses linear acceleration and angular velocity sensors to fix the position of a diver in relation to a reference point. The sensor inputs are corrected by other sensors such as pressure or magnetic sensors.

### RELATED APPLICATION(S)

This application claims the benefit of U.S. Provisional Application No. 60/681,425, filed on May 16, 2005. The entire teachings of the above application(s) are incorporated herein by reference.

### BACKGROUND OF THE INVENTION

This application relates to an underwater personal navigation system, such as may be used by SCUBA divers.

Introduction to Dive Navigation

All divers, novice through experienced, face challenges when navigating underwater. Open water diver certification programs include instruction on basic navigation skills for use on dive activities. This is generally limited to instruction on how to read a compass underwater, followed by directions on how to swim in a fixed direction for a fixed time, and then reversing the direction for a similar time to return to a start location.

As simple and limited as this is, even this skill is difficult for many divers to master, and a typical diver may never use this technique after passing the skills test.

Even if performed properly, the compass-based navigation technique leaves much to be desired. First, it does not take into account underwater currents which can be both strong and invisible making it very difficult for a diver to estimate the error introduced much less compensate for this. Second it does not account for non-straight-line paths which may be either necessary to circumnavigate obstacles, or may just be desirable to enjoy viewing features that are off the chosen path, in caves and channels, etc.

In addition, it should be noted that, even in very good visibility areas, a typical dive site where the boat may be 60 to 100 feet overhead, provides almost no cues that you are directly under the boat unless you get closer to the surface or happen upon a mooring line. A 100 foot dive boat may not even cast a visible shadow when looked at directly from the bottom. This situation is only aggravated by many typical dive sites with less than optimal visibility.

Abandoning the compass can be very disorienting since many dive sites are mixtures of coral heads, sand beds, and other features which are very similar to each other over a wide area making landmark recognition and tracking problematic.

As a result, it is quite common for even experienced divers to rely on guides, familiar with a new dive site, so that they can relax and view the surroundings, knowing that their guide is responsible for getting them back to the boat.

Another indicator of the need for an effective device to aid in underwater navigation is the existence of several alternate solutions which try to meet this need. There are several methods that have found their way to commercially available products. All of these products attempt to address the issues described above but fall short in fully enabling a diver to explore as if they had a true dive guide along. They typically have limited range either from the start point, or from the surface of the water. In addition they can suffer from common situations where their accuracy and even their basic functions can be compromised.

Sonic Rangefinders

In these systems an ultrasonic beacon sends out a signal from the start point of the dive location. This would be either near a boat or the entry point of a shore dive. A receiver device carried by the diver determines distance and direction. This type of system is shown in:
U.S. Pat. No. 3,944,977, 1976, issued to Acks
U.S. Pat. No. 3,986,161, 1976, issued to MacKellar
U.S. Pat. No. 5,570,323, 1996, issued to Prichard

These systems have the advantage of being relatively simple to manufacture and operate. Well designed beacon systems seem to work reasonably well. However, they have shortcomings. For example, they only work when a direct line of sight is available from the diver's location back to the entry point. Thus any objects or thermoclines in the path cause signal to be lost. In addition, such systems are typically limited to a range of about 300 meters or so. Furthermore, on shore dives, the beacon must be placed close to the shore. Without someone remaining on shore to monitor the beacon, it is susceptible to being moved or even being stolen.

GPS Based Systems

The Global Position System (GPS) and similar satellite-based navigation system receivers have become quite inexpensive and enjoy great popularity among land based adventures such as hikers, back-packers, skiers and the like. However, GPS signals do not travel through water. Therefore, to be used for underwater navigation, either the GPS unit must be left on the surface with signals sent underwater somehow to the diver, or an antenna must be placed on surface of the water, with signals sent to underwater GPS equipment. Some examples are shown in:
U.S. Pat. No. 6,701,252, 2004, issued to Brown and Ivan
U.S. Pat. No. 6,791,490, 2004, issued to King
U.S. Pat. No. 6,807,127, 2004, issued to McGeever

GPS based systems have an advantage in that they use the worldwide GPS system, now proven to reliably provide reasonably accurate location information to within several feet.

However, these suffer from several disadvantages in the underwater environment. First, the diver must remain tethered to the surface component via some sort of signal line or antenna cable. This severely limits travel depth and mobility during a dive. Typical systems implemented with this method use cable lengths of fifty feet or less. Recreational dive safety limits support dive depths of greater than one hundred twenty feet so that divers using these devices are limited to only relatively shallow dives. In addition, by tying the diver to a surface line the freedom that is provided by SCUBA (Self Contained Underwater Breathing Apparatus) is compromised. Mobility to travel through wrecks, coral heads and any features which do not provide a direct line path to the surface becomes problematic. The device which should provide enhanced safety and enjoyment may itself become a safety hazard by increasing the probability that a diver may become entangled by the surface line. Furthermore, accuracy is reduced by an uncertainty introduced in the difference between a diver's position and the surface float position.

### SUMMARY OF THE INVENTION

Problems with Existing Underwater Personal Navigation Systems

A more effective personal dive navigation system would significantly enhance the enjoyment of the scuba diving experience by removing the anxiety of correct navigation. These include concerns that getting too far away from the boat resulting in disorientation, a return swim that may be beyond the diver's capabilities, or a dive that takes longer than a scheduled dive time where the air supply may become depleted.

By effectively replacing a personal experienced dive site guide, a navigation system would ideally always let a diver know how far and in what direction the boat is located from their current position. This would enable the diver to explore on random paths led by interesting viewing, rather than navigation concerns. The overall result would be a much more pleasurable dive.

A miscalculation on dive navigation can result in potentially life-threatening situations. If a diver has become disoriented and is swimming in the wrong direction their distance from the return point can become excessive. For example, a diver will typically try to maximize their use of available time to see as much as possible before returning to the dive start point. A typical dive might be scheduled for 45 minutes duration. This would mean that the diver might want to range from the start point for as much as 20 minutes or more before heading back.

If instead of heading back, in fact the diver heads farther away from the boat, he or she could end up being thousands of yards from where they expect to exit the water. If this has been caused by a strong current, it is quite possible that there are even greater currents at the surface. However since the diver is getting close to the dive end time, it is likely that they are also near the end of their air supply, forcing them to surface to both get reoriented and start back to the boat.

If they are now far from the boat, low on air so that they cannot swim underwater the entire distance, and in a heavy current they are in an extremely dangerous state.

By providing accurate navigation information, this kind of situation can be avoided, both enhancing safety as well as improving the experience by reducing anxiety.

Feature Summary of the Present Invention

These and other objectives are met by a personal underwater navigation device provided according to the principles of the present invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a personal underwater Inertial Navigation System (INS) according to the present invention.

FIG. 2 illustrates a three-dimensional coordinate system and body acceleration (a) and rotational velocity (w) vectors in directions (xyz).

FIG. 3 is a flow diagram of steps performed by a digital signal processor.

FIG. 4 shows a typical display that would be used with the handheld unit.

FIG. 5 is a typical graph that might be shown on the screen of a personal computer (PC).

### DETAILED DESCRIPTION OF PREFERRED EMBODIMENTS

A description of preferred embodiments of the invention follows.

Overview

Recent developments and advances in Micro Electro-Mechanical Systems (MEMS) components as well as continuing improvements in the cost, performance and power of microcomputing devices have enabled the miniaturization and cost reduction of an Inertial Navigation System (INS) to the point that it is practical to implement a personal system for use by SCUBA divers and other water sport enthusiasts. This novel approach requires innovation in overcoming the inaccuracies in these devices which will then make it a solution to the navigation problem currently addressed by less effective means.

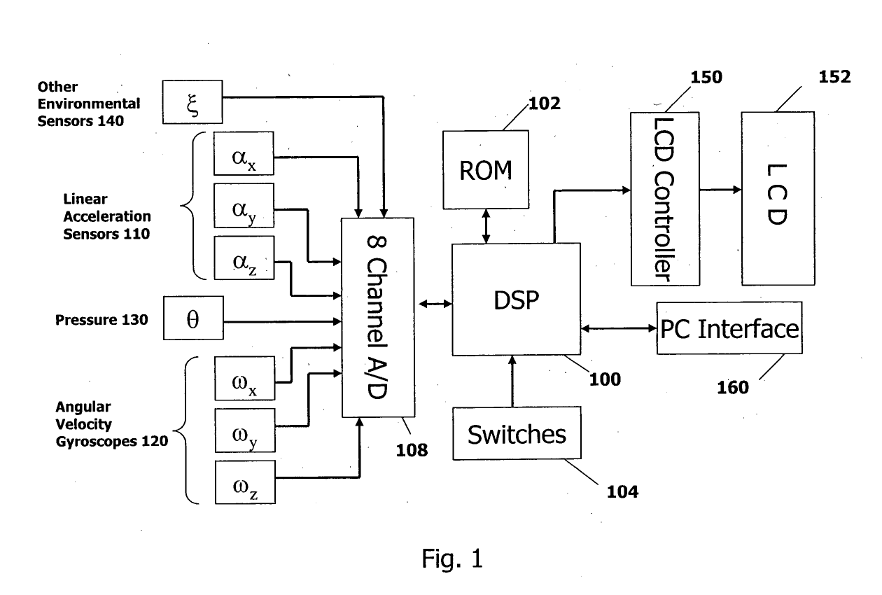

FIG. 1 is high level block diagram of the hardware components of a personal underwater INS according to one possible embodiment of the present invention. The system includes a Digital Signal Processor (DSP) 100, a Read Only Memory (ROM) 102, switches 104, a multi-channel analog to digital converter (A/D) 108, a number of external sensors including linear acceleration sensors 110, angular velocity gyroscopes 120, pressure sensors 130, other environmental sensors 140, a liquid crystal display (LCD) controller 150, an LCD 152 and a Personal Computer (PC) interface.

The various components are preferably packaged in a convenient hand portable waterproof housing, about the same size as a camera or cell phone.

The DSP 100 is used as a primary data processing unit to perform inertial navigation calculations. It functions to read sample values from sensors 110, 120, 130, 140 through the A/D converters 108. Sample values are then compensated for errors to arrive at a position of the diver as computed and logged. The DSP 100 uses a combination of inputs from linear 110 and angular 120 velocity sensors to solve a set of differential equations to convert such readings into estimates of position and attitude, starting off from a known initial position.

The LCD controller 150 and LCD display 152 permit the diver to view his or her current position and the relative position of the boat. The LCD controller 150 operates as a graphical information interface to manipulate the LCD display 152 under control of the DSP 100.

The ROM 102 provides non-volatile memory storage of the program executed by the DSP 100, data, and other information such as calibration data.

The switches 104 acts as mode inputs. For example, the switches may be push buttons that allow selecting different operating modes for the device.

The PC interface 160 provides for an external connection to a PC to enable configuration and setup of the device, as well as for downloading logs after a dive.

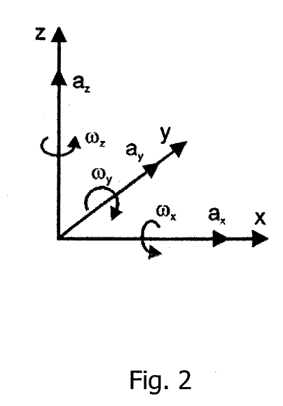

Linear acceleration sensors 110 measure how the diver moves. Since a diver can move in three axes (up & down, left & right, forward & back), a linear accelerometer is needed for each of three axes e.g., in the (x, y, z) planes as shown in FIG. 2. After being read through the A/D converters 108, the three acceleration values (aₓ, a_{y}, a_{z}) are converted to a velocity and position estimate by the DSP 100.

The angular velocity sensors 120 measure how the diver is twisting in three dimensional space. Generally, there is at least one sensor for each of the three axes: pitch (nose up and down), yaw (nose left and right) and roll (clockwise or counterclockwise from the cockpit). The angular velocity gyroscopic sensors 120 thus provide a measurement of rotation of the diver (ωₓ, ω_{y}, ω_{z}) to continuously determine the divers position attitude with respect to the gravitational frame of reference.

The pressure sensors 130 and other environmental sensors 140 provide further physical sensors for detecting information that can enable the DSP 100 to correct for errors present in the accelerometers 110 and in gyros 120. For example, the other environmental sensors 140 may include magnetic, temperature and depth sensors.

Algorithms Executed by DSP 100

Inertial Navigation Systems (INS) have been in use as navigational aids in various water and air craft for a number of decades. The basic known principals involve measuring change of acceleration, velocity and position in a two or three dimensional space of a body in motion. All inertial navigation systems suffer from integration drift, as small errors in measurement are integrated into progressively larger errors in velocity and especially position.

In general the DSP 100 continually calculates the diver's current position, S. The DSP 100 uses known laws of motion of a body in space to relate the position, velocity and acceleration of an object in three dimensions. The position of an object can be represented by values in a Cartesian coordinate system, as was shown in FIG. 2. By determining the body's acceleration (a) in all of these directions, as well as tracking any rotational velocity (ω) on these three axes over time, the position on the body can be tracked from its initial position.

The linear acceleration of the object is directly related to the body's instantaneous position in space. The position with respect to time along any of the three axes {s(t)} can be represented as the double integral of the acceleration of the object in any of the coordinate axes or:
s(t)=∫∫ a(t)dt²

Similarly the angle of orientation with respect to time {φ(t)} can be derived as the integral of the rotation velocity on any of the axes or:
φ(t)=∫ ω(t)dt

This information must be used to cancel the effects of gravity on the acceleration sensors. The angular position in three dimensions provides an indication of the direction of the gravity vector with respect to the diver's current position. This is required to calculate the effect of the gravitational acceleration component on the three acceleration sensors. Since gravity is indistinguishable from a constant acceleration towards the earth's center, it must be tracked and subtracted from the raw acceleration readings before they are integrated to yield velocity and position information.

Other algorithms, and even other types of sensors, can be used to determine position and this invention is not limited to the techniques discussed herein.

Physical Implementation of Sensors 110 and 120

Currently there are low cost MEMS (Micro-machined Electro-Mechanical System) sensors that can measure acceleration and rotation velocity. These sensors provide the basic input signals needed to track an object in three dimensions according to the above equations.

One challenge however, is that these sensors introduce error signals into the measurements that they take. Further errors are introduced in any other components in the path before the signals are digitized, as well as in the digitization process itself. The digitization results in a finite resolution precision to which the inputs can be represented which can result in an additional offset in readings.

The effect of these sources is to introduce drift in the derived values of velocity and position when they are integrated. These drifts tend to be cumulative in velocity and increase as the square of the offsets in positional tracking.

Error Compensation of Sensors 110 and 120

Left unchecked, these error sources will induce geometrically increasing drifts to the position measurements over time. In order to avoid this problem, additional environmental information from sensors 130 and 140 can be used to validate the inertial position calculation and periodically introduce correcting input signals to cancel error inputs and improve the overall accuracy of the system. The inertial tracking system models position, velocity, rotation and direction, the external sensors 110, 120, 130, 140 provide independent readings on any of these values. In the preferred correction scheme, these sensed values are introduced into the system to back-calculate inertial error vectors and subtract them at their source.

One such potential input is a magnetic compass direction provided by sensors 140. As the inertial system tracks its position relative to its perceived vertical, it should always see an average vertical acceleration equal to the earth's gravitational pull. This needs to be calculated as a relatively long-term average since current movements and accelerations of the object will affect the instantaneous perception of both vertical position as well as vertical acceleration.

Other possible error-compensating inputs would include any independent position, depth or direction information pertaining to any or all of the three axes.

INS Relationship to Underwater Navigation of a SCUBA Diver

The nature of personal underwater navigation provides specific characteristics that also bound the requirements and potential characteristics of a device using the above theoretical basis.

Typical desirable operating characteristics would be as follows:

| | |
|---|---|
| Total dive time: | 1 Hour or greater |
| Positional Accuracy | 15 Meters or less |
| Display Modes: | Distance and Direction to start |
| | Return Path |

Dive Time

This is typically bounded by available air or NITROX supply limits, as well as the depth of the dive. For recreational diving, relatively shallow dives of 30 feet or less might exceed this time. However single dives of longer than 30-45 minutes in length are unusual when the maximum depth is greater than 50 feet. In addition, shallow dives tend to be in areas where navigation is less of a challenge and the start point of a boat or shore are relatively easy to find.

Positional Accuracy

A diver will want to return at the end of their dive to the original start point or fairly close to this position. If the start point was a boat, the boat itself is probably 50 to 200 feet in length. In this case returning to within 100 feet or so of the start position should place the diver in a location where they will see the drop lines from the boat as they surface. So a positional accuracy within 15 meters, or 45 feet over the course of an hour should provide adequate accuracy to comfortably locate the boat.

If the dive is a shore dive, the intention will be to locate the entry point for the dive. Again, tracking to within 50 feet or so of the start point should be more than adequate to locate the buoy or shore points that would be familiar for return.

Flow Chart Description

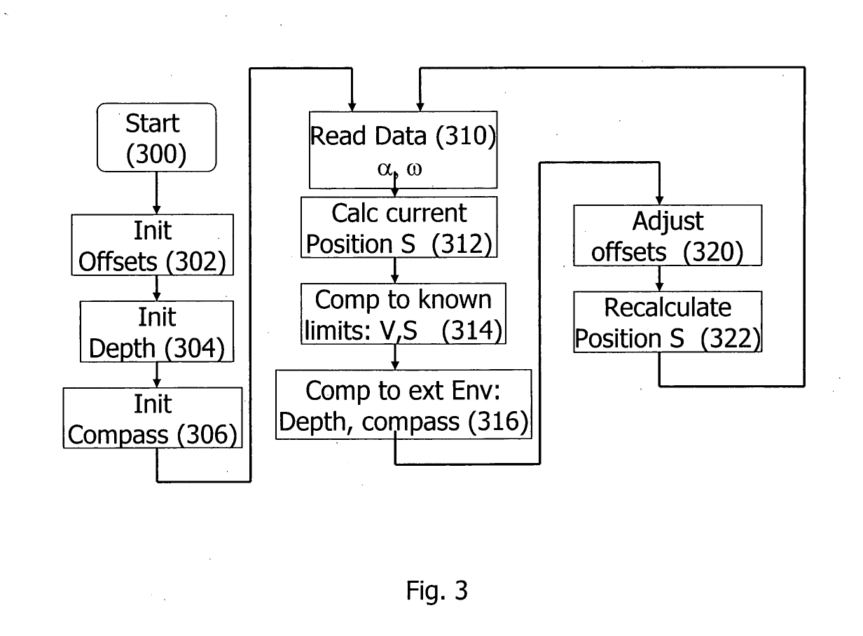

FIG. 3 is a flow chart of the steps that would typically be performed by the DSP 10 to calculate and maintain diver position according to the present invention.

From a first step 300 several initialization steps would be performed. For example, step 320 would include initializing offsets offset values for all sensors, based on expected starting conditions.

In step 304, an initial depth is set, such as at sea-level or a known amount below sea-level. These may be based on inputs from the user, or as measured from sensors 140 such as a pressure sensor.

A final initialization step 306 initializes a compass heading value based for example on a compass input sensor 140.

Processing then proceeds to a main processing loop beginning with step 310. Here digital values corresponding to angular velocity (ω) and linear acceleration (a) for all axes are read from the velocity gyroscopes 120 and linear acceleration sensors 110. Readings are preferably taken continuously at a predetermined rate, such as a rate of between 100 and 1000 samples per second. For purposes of accurate calculation and reference, a local working memory in the DSP 100 might store for example, at least one seconds worth of samples.

In step 312 the current position, S, is then calculated from the sensor data read in step 310. The position is typically calculated in three dimensions according to known equations as referenced above.

In step 314, the current velocity, V, and position, S, are compared to known limits. For example, if it is physically impossible for a difference in either one to have occurred in the time since the last measurement, an error might be indicated.

In the next step 316, the calculated position S is then compared to a predicted position. In particular, the calculated position is compared to a position predicted by one or more algorithms applied to the external environmental sensors. A predicted position might be determined from a depth and compass heading, for example, as described more fully below.

After comparing the external environmental position calculation to the calculated position, in step 320, sensor offset values are adjusted. This step thus forces the calculated values to match the depth and compass readings. The position S is then recalculated in step 322 using the new offset values.

The sequence of steps from step 310 through step 322 are then repeated until the dive ends.

Display Modes

The most intuitive and rudimentary display mode will use a compass rose type of display with an arrow pointing in the direction of the start point with a large numeric readout of distance to the point of origin. This will enable the diver to keep track of how far they must swim to return, as well as orientation for their return path.

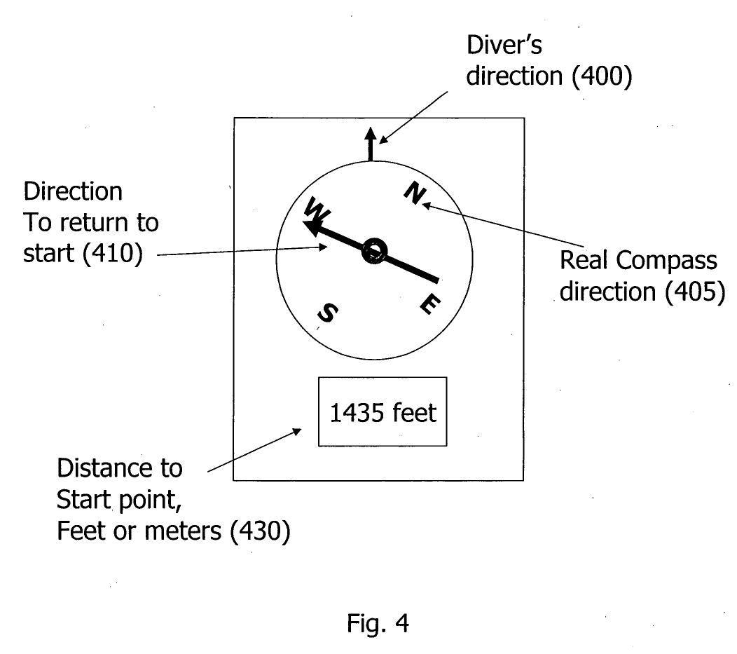

FIG. 4 shows one example of such a mode that might be utilized in connection with the LCD 152. A compass rose is used to display real compass direction, such as by displaying a familiar (N)orth, (E)ast, (S)outh, and (W)est compass points with the N pointing to the north.

The diver's present direction can be then indicated by an arrow 400 pointing in the general direction of present movement.

Centered on the rose is an arrow indicating a direction to return to start 410.

Additional data could also be displayed such as a distance to start (430) or other information such as remaining dive time, etc., of importance to the diver.

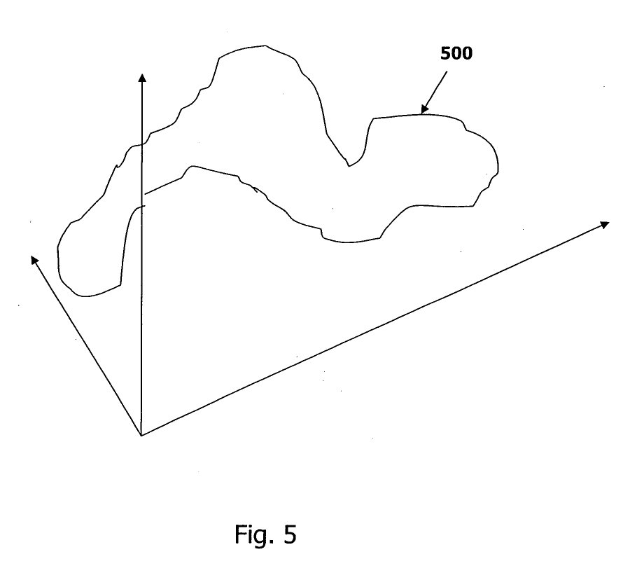

A secondary display mode, which may only be available on some models having a more expensive display, might display a trace of the path that was followed to arrive at the current location, along with an arrow directing the diver which direction to swim to follow the same path back to the boat. An example is shown in FIG. 5. This mode would be useful in the case where the dive location contains many obstructions to a straight line trajectory back to the start point. For example if the path taken was among large coral heads or even through caverns, this could guide the diver back along the original path without having to get out of or go over obstructions.

Environmental Input From Sensors 140 Used for Error Cancellation

The underwater dive environment provides several sources of independent information, such as various sensors 140 that can be used for continual correction and convergence of inertial navigation calculations. One is the gravitational factor described above which is available as an information source underwater as well.

Another potential reference is an independent magnetic compass reading. Compass orientation can be measured underwater in either two or three dimensions providing an external stable reference independent of the INS world. This can be compared to the inertial navigation system's calculation of the direction it is facing and used to back-calculate error sources that would account for measured offsets.

A third information source is the vertical position of the diver. Above the water, atmospheric pressure provides a rough estimate of vertical position on the earth's surface. However this value varies significantly based on weather conditions. Underwater however, the density of the medium provides a more consistent relationship between pressure and vertical position. This information can be used to correlate the INS's perception of current vertical position, or depth changes from the start point, to compensate for drift in the calculated model of current position.

These are but three examples of either independent or partially independent measurements of environmental conditions that can be used to lessen the effects of error based drift in the system. Others can also be used, but the minimum of external sources adequate to meet the desired accuracy would yield the lowest cost and optimal solution for the system.

While this invention has been particularly shown and described with references to preferred embodiments thereof, it will be understood by those skilled in the art that various changes in form and details may be made therein without departing from the scope of the invention encompassed by the appended claims.

What is claimed is:

1. A personal hand portable underwater navigation device comprising:
a set of linear acceleration sensors for determining linear acceleration of a user of the device in a three dimensional (x, y, z) coordinate space:
a set of angular velocity sensors, for measuring rotation in (x,y,x) spave of the user of the device;
a digital signal processor for
reading sample values from the linear acceleration sensors and the angular velocity sensors and converting the information to a velocity and position estimate; and.
comparing the velocity and/or position estimate to a corresponding predicated value determined by measurements from an environmental sensor or sensors.
